(19) United States
(12) Patent Application Publication
(10) Pub. No.: US 2025/0376092 A1
(43) Pub. Date: Dec. 11, 2025

(54) CHILD SEAT WITH SIDE IMPACT PROTECTION

(71) Applicant: Evenflo Company, Inc., Miamisburg, OH (US)

(72) Inventors: Yuancheng HU, KUNSHAN (CN); Zhiyong Kuang, KUNSHAN (CN); Wei XU, KUNSHAN (CN); Bingqing Zhou, KUNSHAN (CN)

(21) Appl. No.: 19/226,379

(22) Filed: Jun. 3, 2025

Related U.S. Application Data
(60) Provisional application No. 63/657,604, filed on Jun. 7, 2024.

(51) Int. Cl. B60N 2/28

(52) U.S. Cl. CPC B60N 2/2884; B60N 2/2821; B60N 2/2869

(57) ABSTRACT

A child seat may include a seat shell connected to a base with the seat shell being movable between a forward-facing position and a rearward-facing position. First and second impact protection structures may be positioned on either side of the seat shell, with the first impact protection structure having a first impact surface the second impact protection structure having a second impact surface. The impact protection structures may comprise an attachment structure, a cover and an energy-absorbing element. A common transverse plane parallel to a bottom surface of the base can intersect the first and second impact surfaces in both the forward-facing and rearward-facing positions.

### CROSS-REFERENCE TO RELATED APPLICATIONS

This application, titled “Child Seat With Side Impact Protection,” claims the benefit of priority of U.S. Prov. App. No. 63/657,604, filed Jun. 7, 2024, and titled “Child Car Seat With Protection Mechanism.” The entirety of the aforementioned application is incorporated by reference herein.

### BACKGROUND

In the United States and many other countries, car seats for infants or children (hereinafter collectively “child seats”) are required by law for children up to a certain age or size. Child seats intended for infants are typically rear-facing while child seats for older children are forward-facing, though a growing segment uses a “convertible” child seat that may be oriented in either a rear-facing position or a front-facing position.

For all child seats, an increasing focus is to provide impact protection features to protect a child seat occupant from a crash, accident, or other incident (collectively, “side impact events”) that occur on a side of the vehicle that the child seat is secured within.

### BRIEF DESCRIPTION OF THE DRAWINGS

The present disclosure is described in detail below with reference to these figures.

FIG. 1 illustrates a perspective view of a first example of a child seat in accordance with aspects of the present disclosure.

FIG. 2 illustrates a side view of the child seat of FIG. 1 with the shell in a forward-facing position.

FIG. 3 illustrates a side view of the child seat of FIG. 1 with the shell in a rearward-facing position.

FIG. 4 illustrates an outline of the child seat of FIGS. 1-3 with the seat shell in both the forward-facing position and the rearward-facing position.

FIG. 5 illustrates an exploded view of the inner shell, the outer shell, and components of a side impact protection structure of the child seat of FIG. 1.

FIGS. 6A-B illustrate views of the inner shell of the child seat of FIG. 1.

FIGS. 7A-B illustrate views of the outer shell of the child seat of FIG. 1.

FIGS. 8A-B illustrate views of a cover of the side impact protection structure of FIG. 1.

FIGS. 9A-B illustrate views of an attachment structure of the side impact protection structure of FIG. 1.

FIGS. 10A-B illustrate views of an energy-absorbing element of the side impact protection structure of FIG. 1.

FIG. 11 illustrates a schematic face-on view of a second example of a child seat in accordance with aspects of the present disclosure.

### DETAILED DESCRIPTION

The present disclosure relates to child seats. More particularly, the present disclosure relates to child seats having one or more external-facing side impact protection structures.

Conventional solutions for protecting a child seat occupant during a side impact event typically utilize one or more energy-absorbing elements extending from one or more side surfaces of the child seat. These side impact protection elements are typically positioned adjacent relative to the position of the occupant and their body parts (e.g., the occupant's head), rather than taking into consideration how the positioning of the side impact protection elements might affect the motion of the child seat itself during a side impact event. Moreover, for convertible child seats that can change configuration so that the orientation of the occupant can be either forward-facing or rearward-facing, the positioning of these side impact protection elements relative to the vehicle may change significantly from one configuration to the other, which can change their effectiveness to mitigate the effects of a side impact event on the child seat and its occupant.

The present disclosure describes several different approaches to positioning side impact protection elements for a child seat relative to a side door armrest of a vehicle that the child seat is installed in. The approaches can be used separately or together in the same child seat.

In the first approach, the side impact protection element is positioned so that it abuts or minimizes the distance between the side impact protection element and an interior-facing side surface of the vehicle door armrest. Without being bound by any specific theory, it is hypothesized that minimizing the distance between the side impact protection structure and the side surface of the armrest (which, in a side impact event, will often be the first element of the vehicle to impact the side of the car child seat), will reduce the amount of energy that the child seat experiences upon initial contact. Since kinetic energy is a square function of velocity, reducing the distance between the two surfaces also reduces the time between the side impact event and the impact of the two surfaces, thus reducing the speed at which the two surfaces impact each other. More of the energy from the side impact event may thus be experienced by the child seat as a direct-contact pushing force over time by the vehicle door armrest versus a hitting or impulse force that occurs over a shorter timeframe requiring more force to be transferred in a shorter duration of absorption time, which in turn may enhance the resulting impact absorption effects for an occupant within the child seat.

In a second approach, a side impact protection structure is positioned to minimize the amount of roll and/or torque around a longitudinal axis that a child seat may be subject to during a side impact event. In an example, a side impact protection structure is positioned so that its impact surface does not impact the vehicle door armrest but instead impacts another portion of the door at about the same time that the vehicle door armrest impacts another part of the child seat, such as a second impact surface. Without being bound by any specific theory, it is hypothesized that such a configuration will reduce a rolling (e.g., rotation about the longitudinal axis) of the child seat, during a side impact event which might otherwise cause the top of the child seat to generate significant speed during a rolling motion that could then result in a secondary impact in the region of the occupant's head as the top of the seat subsequently impacts another part of the car door.

In both approaches described above, one or more side impact protection structures may comprise a side impact protection structure that includes an attachment structure that attaches to a seat shell of a child seat (as opposed to a child seat base), into which an energy-absorbing element (e.g., a foam or foam-based component) is placed or secured. The attachment structure may be configured in size and shape for receiving and holding the energy-absorbing element, that can be inserted to fit closely within a cavity in the attachment structure. A rigid and robust cover may then be placed over at least a portion of the attachment structure, into which the foam component is held. The cover is securely attached to the attachment structure. The side impact protection structures may be placed in one or more locations on the exterior of the child seat shell and protrude outward from the main body of the seat shell. Thus, in the scenario of a side impact of a vehicle, the side impact protection structures for side impact would be the first point(s) of contact and would absorb and dissipate forces being transferred from the side impact protection structures to the seat shell-thus enhancing protections to the seat occupant. Additionally, the side impact protection structures are placed, shaped, and oriented in a manner that does not interfere with or prevent the seat shell from being placed into and secured to the child seat base. The side impact protection structures for side impact may be placed in one or more regions, but may share an overall structure (attachment structure, foam component, cover). In some examples, the cover attaches to the outer shell as well as the attachment structure, and the energy-absorbing element, may also at least partially abut an external shell portion of the seat shell, while the attachment structure is attached to the inner portion of the seat shell.

Having these multiple points of attachment can further improve the ability of the side impact protection structure to dissipate energy from a side impact event through more of the structure of the child seat. In examples, the attachment structure can abut (directly or indirectly) a rigid structural element, to further provide additional energy dissipation

In the following detailed description, reference is made to the accompanying drawings, which form a part hereof. In the drawings, similar symbols identify similar components, unless context dictates otherwise. The illustrative examples described in the detailed description and drawings are not meant to be limiting and are for explanatory purposes. Other examples may be utilized, and other changes may be made, without departing from the spirit or scope of the subject matter presented herein. It will be readily understood that the aspects of the present disclosure, as generally described herein and illustrated in the drawings, may be arranged, substituted, combined, and designed in a wide variety of different configurations, each of which are explicitly contemplated and form a part of this disclosure.

It should be noted that some of the terms used herein may be relative terms. For example, the terms “upper” and “lower” and the terms “forward” (or “front”) and “rearward” (or “rear” or “back”) are relative to each other in location, i.e., an upper component is located at a higher elevation than a lower component in a given orientation, but these terms may change if the structure is flipped. An intermediate component, on the other hand, is always located between an upper component and a lower component regardless of orientation. The terms “horizontal” and “vertical” are used to indicate direction relative to an absolute reference, i.e., ground level. However, these terms should not be construed to require structures to be absolutely parallel or absolutely perpendicular to each other. For example, a first vertical structure and a second vertical structure are not necessarily parallel to each other. The terms “top” and “bottom” are used to refer to surfaces where the top is always higher than the bottom relative to an absolute reference, i.e., the surface of the Earth when the component is used as intended. The terms “upwards” or “upwardly” and “downwards” or “downwardly” are also relative to an absolute reference; upwards is always against the gravity of the earth. The terms “forward” and “rearward” or “rear” with respect to a position or orientation are opposite one another along a common direction, and an “intermediate” position is always located between a forward position and a rearward position.

The terms “operative to” and “configured to” and similar terms are used herein to describe that a particular component has certain structural features designed to perform a designated function. Such components should be construed as having the expressed structure, with the designated function being considered part of the structure. As used herein and as will be appreciated by those skilled in the art, the term “child seat” encompasses child seats, restraints, boosters, and the like for children, infants, toddlers, and the like.

Unless indicated otherwise, all measurements provided herein are taken when a component(s) is at standard ambient temperature and pressure (298.15 K and 100 kPa). As used herein, the terms “substantially” and “about” mean within +5% of an indicated value.

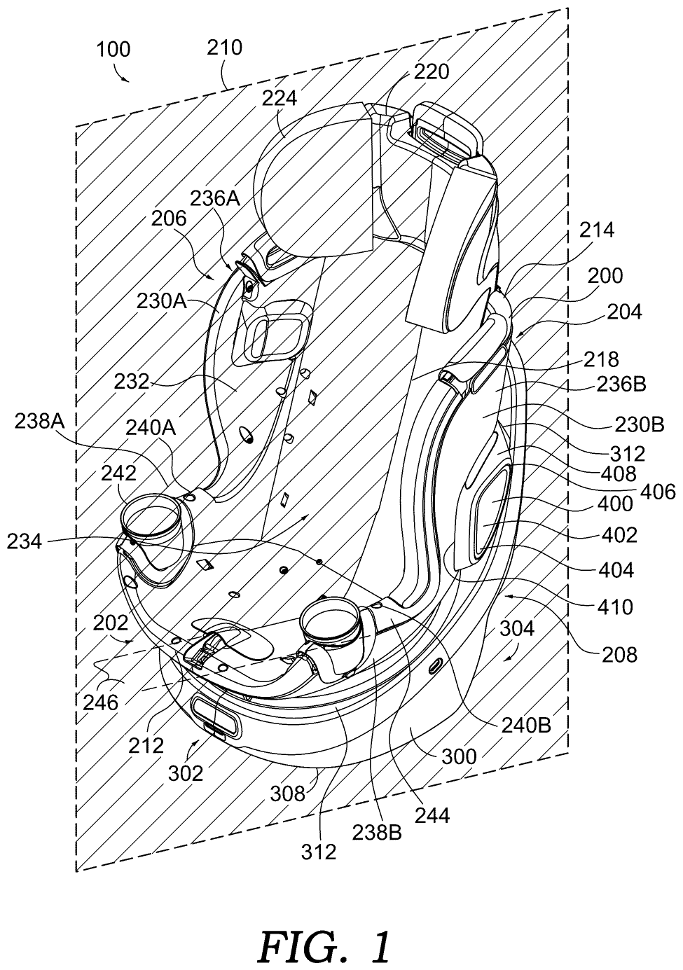

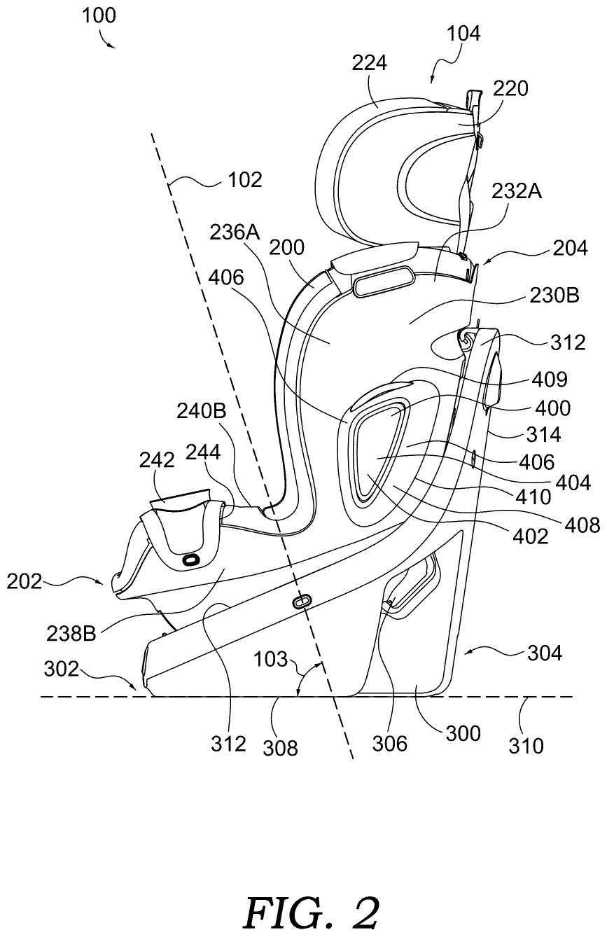

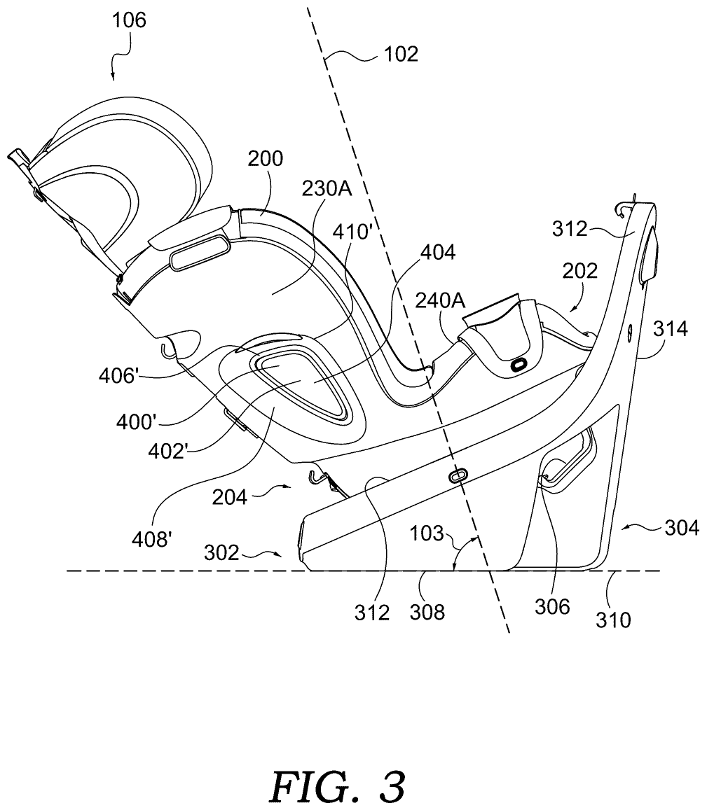

FIGS. 1-3 illustrate a child seat 100 designed for transporting an infant or child in a vehicle, such as a car. The child seat 100 generally includes a seat shell 200 and a base 300 that supports the seat shell 200 in the vehicle. In examples, the seat shell 200 may be rotatable with respect to the base 300 about an axis 102. In examples, the orientation of the axis 102 is fixed relative to the base 300 and the seat shell 200 is selectively rotationally positionable about the axis 102 in a variety of different positions (e.g., e.g., a rearward-facing position, a forward-facing position, an intermediate loading position, etc.). In particular, the seat shell 200 of FIGS. 1-3 is selectively positionable in at least a forward-facing position (FIG. 1 and FIG. 2) and a rearward-facing position (FIG. 3).

FIGS. 1 and 2 illustrate the seat shell 200 supported on the base 300 in a forward-facing position 104. With reference to FIG. 2, in the forward-facing position 104, a forward end 202 of the seat shell 200 and a front end 302 of the base 300 face a common direction (e.g., toward the forward end of the vehicle when installed), and a rear end 204 of the seat shell 200 and a rear end 304 of the base 300 face a common direction (e.g., toward the rear end of the vehicle when installed). The base 300 may be releasably secured to the seat of the vehicle, such as by using a vehicle seat belt (e.g., lap belt) or other tether threaded through a belt path 306, with the base forward end 302 facing towards the front of the vehicle and the base rear end 304 facing towards the rear of the vehicle. In other examples, the base 300 may include an integrated anchor-and-tether system, such as LATCH (Lower Anchors and Tethers for Children) system, to secure the base 300 to the vehicle without using the vehicle's seat belts. In the example of FIG. 2, axis 102 is tilted forward towards the front end 302 of the base 300. In an example, angle 103 is between 57 and 77 degrees, or about 67 degrees.

The bottom surface 308 of the base 300, when resting upon a solid horizontal planar surface, will define a bottom surface plane 310. The top surface 312 of the base 300 is configured to receive and/or interface with the seat shell 200. In examples, the seat shell 200 may be removably attached to the base 300, allowing the seat shell to be transported separate from the base 300, such as being held by hand or connected to a different base structure, such as a stroller base or a base that is installed in another vehicle. In other examples, the seat shell 200, while being rotatable relative to the base 300, is not intended to be disengaged from the base 300 during ordinary use.

FIG. 3 depicts the seat shell 200 supported on the base 300 in a rearward-facing position 106. As can be readily understood with reference back to FIG. 1 and FIG. 2, the seat shell 200 is rotated with respect to the base 300 about 180 degrees between the forward-facing position 104 of FIG. 2 and the rearward-facing position 106 of FIG. 3. Stated differently, the seat shell 200 generally faces one direction in the forward-facing position 104 and an opposite direction in the rearward-facing position 106. With reference to FIG. 3, in the rearward-facing position 106, the rear end 204 of the seat shell 200 and the front end 302 of the base 300 face a common direction (e.g., toward the forward end of the vehicle when installed), and the forward end 202 of the seat shell 200 and the rear end 304 of the base 300 face a common direction (e.g., toward the rear end of the vehicle when installed).

While only the forward-facing position 104 and the rearward-facing position 106 for the seat shell 200 are shown in FIGS. 1-3, in examples the seat shell 200 may be configured to be rotatable and secured into additional positions (e.g., 90 degree intermediate position), which may, by way of example, facilitate helping a child into and out of the child seat.

The seat shell 200 may support and stabilize an occupant (e.g., an infant or child) therein and/or thereon. The seat shell 200 of FIGS. 1-3 includes a first side 206 and a second side 208 opposite the first side 206 across a longitudinal plane 210. In the example of FIGS. 1-3, the longitudinal plane 210 is a midline plane that generally bisects the seat shell 200 extending between the forward end 202 and rear end 204.

In particular, the seat shell 200 may include a shell lower section 212 and a shell back 214 that extends upwardly from the shell lower section 212 proximate the rear end of the seat shell 200. The shell lower section 212 may generally include a seat pan 216 that serves as a seating surface for the occupant, and the shell back 214 comprises a seat back 218 that serves as a backing surface for the occupant to lean or lie back against while seated on the seat pan 216.

The seat shell 200 may include a headrest 220 configured to support the occupant's head. In some examples, the headrest 220 may be adjustable along the length of the seat back 218 to accommodate occupants of different heights. The headrest 220 may be selectively slid up and down on a pair of grooves 222 in the seat back 218. The headrest 220 may have angled side wingtips 224 to further support and shield an occupant's head.

The seat shell 200 of FIGS. 1-3 includes a first sidewall 230A and a second sidewall 230B. The first sidewall 230A may be positioned adjacent to the shell back 214 and the seat pan 216 on a first side 206 of the seat shell 200, while the second sidewall 230B may be positioned adjacent to the shell back 214 and the seat pan 216 on a second side 208 of the seat shell 200. Generally, the second sidewall 230B is positioned opposite the first sidewall 230A, across the longitudinal plane 210. In the example shown in FIG. 1, there is a curved or rounded transition from the edges of the seat back 218 to the first sidewall 230A and second sidewall 230B.

In the examples discussed herein, the first side 206 corresponds to a right side and/or right portion of the seat shell 200 and the second side 208 corresponds to a left side and/or left portion of the of the seat shell 200 when the seat shell is in the forward-facing position 104, for instance. However, it will be understood that in other aspects not shown herein, the first side corresponds to a left side and/or portion while the second side corresponds to a right side and/or portion. The inner surfaces 232 of the first sidewall 230A and the second sidewall 230B, together with the seat pan 216 and the seat back 218, define an occupant cavity 234 that surrounds an occupant seated within the seat shell 200. The rear portions 236A and 236B of the first sidewall 230A and the second sidewall 230B proximate the rear end 204 of the seat shell 200 may extend proximate the head and shoulder regions of the occupant cavity 234. The front portions 238A and 238B of the first sidewall 230A and the second sidewall 230B may form first shell armrest 240A and second shell armrest 240B. In examples, one or both armrests 240A and 240B may include features such as removable cup holders 242. The armrests 240A and 240B may each have an exterior edge 244 spaced a first distance 246 away from the longitudinal plane 210. In aspects, the inner surfaces 232 of the sidewalls may include one or more side impact protection elements that are configured to cushion or deflect an impact of the occupant with one or both of the sidewalls. Although not shown, it should be understood that the seat shell 200 may include softgoods (e.g., textile coverings and/or cushions) extending over part or all of the surfaces defining the occupant cavity 234 (e.g., inner surfaces 232, seat pan 216 and seat back 218) and headrest 220. Additionally, the seat shell 200 may include one or more belts, such as shoulder and thigh belts and a crotch belt connected with a five-point harness, to secure an occupant within the occupant cavity 234.

A side impact protection structure 400 can be seen on the exterior surface of the second sidewall 230B, proximate the rear end 204. A corresponding side impact protection structure 400 is positioned on the first sidewall 230A in a generally symmetrical position about the longitudinal plane 210. As further described herein, each side impact protection structure 400 may comprise a cover 402 that extends externally from the first sidewall 230A or second sidewall 230B away from the longitudinal plane 210. The cover 402 may include an impact surface 404 that is distalmost to the longitudinal plane 210. In the example of FIGS. 1-3 the impact surface 404 is generally triangular in shape but other shapes, configurations and orientations are possible. Extending from a perimeter 406 of the impact surface 404 is a collar 408 that surrounds the perimeter 406 and extends to the exterior surface of the first sidewall 230A or second sidewall 230B, where it meets the first sidewall 230A or second sidewall 230B along a collar edge 410. In examples, a bumper 409 made extend from the sidewall 230 along one or more portions of the collar edge 410.

In the example of FIG. 1, the side impact protection structure 400 is positioned proximate the rear end 204 of the seat shell 200, along the curved or rounded portion of the seat shell 200 where the second sidewall 230B extends from the shell back 214. Correspondingly, the collar 408 has a varying width between the impact surface perimeter 406 and the collar edge 410 so that the impact surface 404 is generally parallel with the longitudinal plane 210.

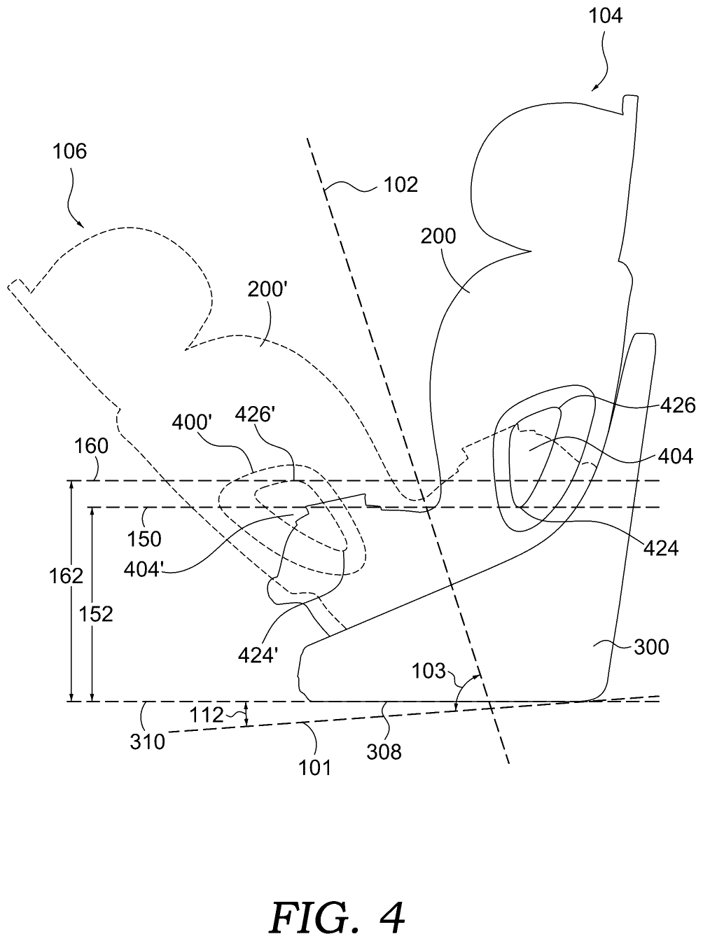

Turning to FIG. 4, an outline of the child seat 100 with the seat shell 200 in both the forward-facing position 104 (solid lines) and the rearward-facing position 106 (200′ in dashed lines) is shown. Accordingly, the relative positioning of the side impact protection structure 400 on the second sidewall 230B and the side impact protection structure 400′ on the first sidewall 230A′ in the rearward-facing position 106 is depicted. When the base 300 of the child seat 100 is secured to a vehicle, the bottom surface plane 310 will sometimes be angled slightly from a horizontal plane 101 that is parallel to the ground, with the front edge of the vehicle seat plane higher than the rear edge, to increase comfort of a traditional sitting occupant. As depicted in FIG. 4, the bottom surface plane 310 may be angled at an angle 112 between 0 and 10 degrees relative to a horizontal plane 101 that is parallel to the street or other ground surface supporting the vehicle.

As seen in FIG. 4, the first side impact surface 404 and the second side impact surface 404′ are both intersected by a first common transverse plane 150, which is aligned with a top edge 426 of the side impact surface 404 in the forward-facing position, and a second common transverse plane 160, a which is aligned with a bottom edge 424′ of the side impact surface 404′ in the rearward-facing position. Each of the common transverse planes 150 and 160 are parallel to the bottom surface plane 310. While only two common transverse planes are illustrated in FIG. 4, it is to be appreciated that any number of transverse planes parallel to the bottom surface can be defined between the first common transverse plane 150 and the second common transverse plane 160 that also intersect both the first side impact surface 404 and the second side impact surface 404′ in both the forward-facing position 104 and the rearward-facing position 106.

In the example child seat 100, the first common transverse plane 150 is spaced from the bottom surface plane 310 by a first distance 152 and the second common transverse plane 160 is spaced from the bottom surface plane 310 by a second distance 162. The positioning of the side impact protection structures 400, and thus the first distance 152 and the second distance 162, may be selected so that at least a portion of one of the side impact surface 404 or the side impact surface 404′ will be positioned to make initial contact with a vehicle door armrest during a side impact event when the child seat 100 is secured to a vehicle car seat adjacent to the vehicle door for a range of different vehicle models, regardless of whether the seat shell 200 is in the forward-facing position 104 or the rearward-facing position 106. In examples, the first distance 152 may be between 15 cm and 30 cm, or about 23 cm. In examples, the second distance 162 may be between 25 cm and 40 cm, or about 27 cm. In examples, the difference between the first distance and the second distance is at least 4 cm.

In some examples, the seat shell 200 may be reclinable with respect to the base 300 in one of the positions, e.g., the rearward-facing position 106, such that the seat shell 200 is selectively reclinable between a plurality of recline positions (e.g., an upright position, a fully-reclined position, an intermediate-reclined position). However, in such examples a common transverse plane parallel to the bottom surface plane 310 may still be defined that intersects the first impact surface 404 and the second impact surface 404′ in the plurality of recline positions when the seat shell 200 is in both the forward-facing position 104 and the rearward-facing position 106.

In the example of FIG. 4, the positions of the side impact protection structures 400 and 400′ in the forward-facing position 104 and the rearward-facing position 106 do not overlap with each other. In other examples, the positions of the side impact protection structures 400 and 400′ in the forward-facing position 104 and the rearward-facing position 106 may overlap with each other.

It is to be appreciated that while the child seat 100 described in FIGS. 1-3 has a seat shell 200 that is rotatable while being engaged with the base 300, which stays in a relatively fixed orientation to the vehicle seat to which it is attached, the advantageous positioning of the side impact protection structures 400 described above may be practiced with other examples of child seats in which the orientation of the seat shell 200 relative to the vehicle door armrest 120 changes using different methods. For example, a child seat may have a seat shell that changes orientation relative to its base by being lifted out of the base entirely before being rotated and reinserted into the base in a different orientation.

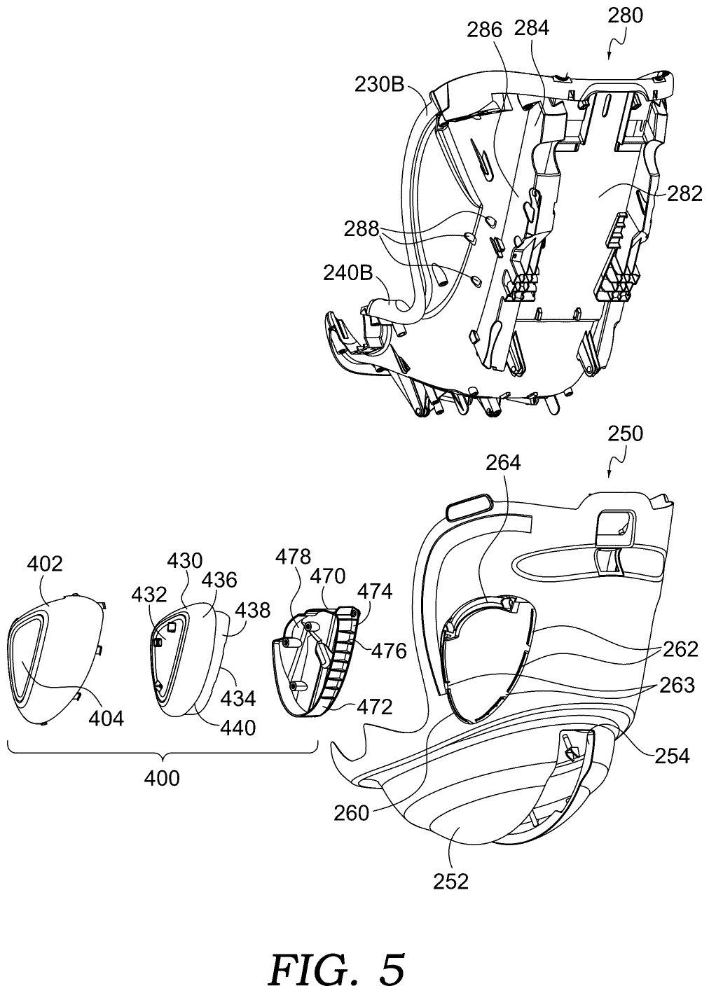

Turning to FIG. 5, an exploded view of the seat shell 200 and one or more side impact protection structures 400 is depicted. Seat shell 200 comprises an outer shell portion 250 and an inner shell portion 270, while side impact protection structure 400 generally comprises the cover 402, and attachment structure 470, and an energy-absorbing element 430 that is disposed within a cavity formed by the cover 402 and the attachment structure 470. Forming the seat shell 200 from two connecting portions such as outer shell portion 250 and inner shell portion 270 allow for various mechanisms or other components to be housed within the seat shell 200 and to facilitate the insertion and positioning of these components during assembly.

In examples, the cavity formed by the cover 402 and attachment structure 470 is fully enclosed by the cover 402 and attachment structure 470. In other examples, as further described herein, the cavity may only be partially enclosed by the cover 402 and the attachment structure 470.

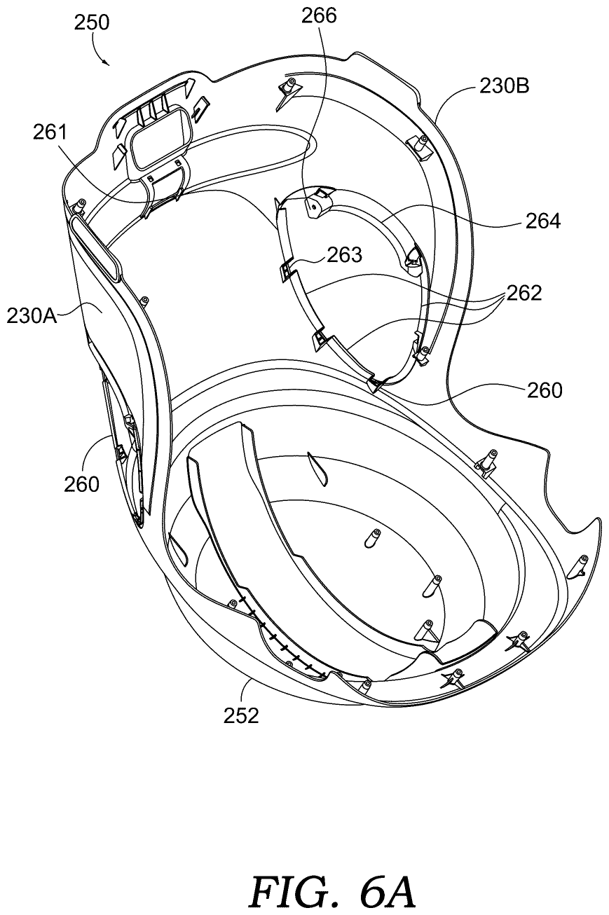

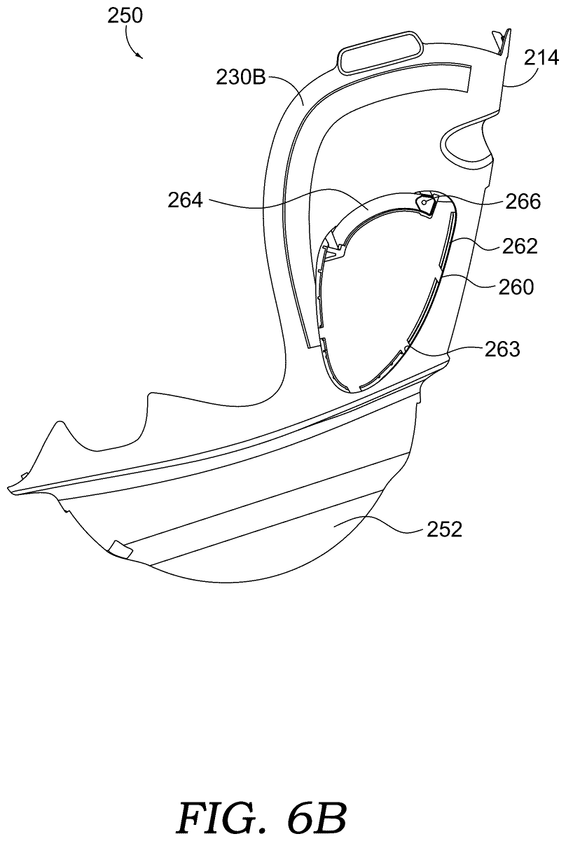

Turning to FIGS. 6A and 6B, the outer shell portion 250 may include a bottom section 252. The bottom section 252 may interface with a receiving portion (e.g., a cavity) of the base 300, which may generally operate to support the seat shell 200 for rotation with respect thereto. In the example of FIGS. 6A and 6B, the bottom section 252 of the seat shell 200 is curved or convex so as to at least partially define a dome shape. In this way, the bottom section 252 of the seat shell 200 may be shaped complementary to a concave, bowl-shaped receiving portion of the base 300. In examples, the bottom section 252 may include a recess 254 through which a locking mechanism and/or recline mechanism (not shown) can engage with corresponding structures in the base 300 to allow the seat shell 200 to rotate, engage/disengage, and/or recline with respect to the base 300.

Each of the first sidewall 230A and the second sidewall 230B include an outer shell apertures 260. Each of the two outer shell apertures 260 has a perimeter 261 that generally corresponds to the shape of the collar edge 410 of the cover 402. A flange 262 may extend from the perimeter 261, with a plurality of tab receiving cutouts 263 corresponding to the plurality of tabs 412 of the cover 402. The outer shell portion 250 may also include an attachment flange 264 along a portion of the aperture perimeter 261 where the bumper 409 may be attached. The attachment flange 264 may have one or more fastener ports 266 through which a fastener may be inserted to engage with a fastener receiver on the bumper.

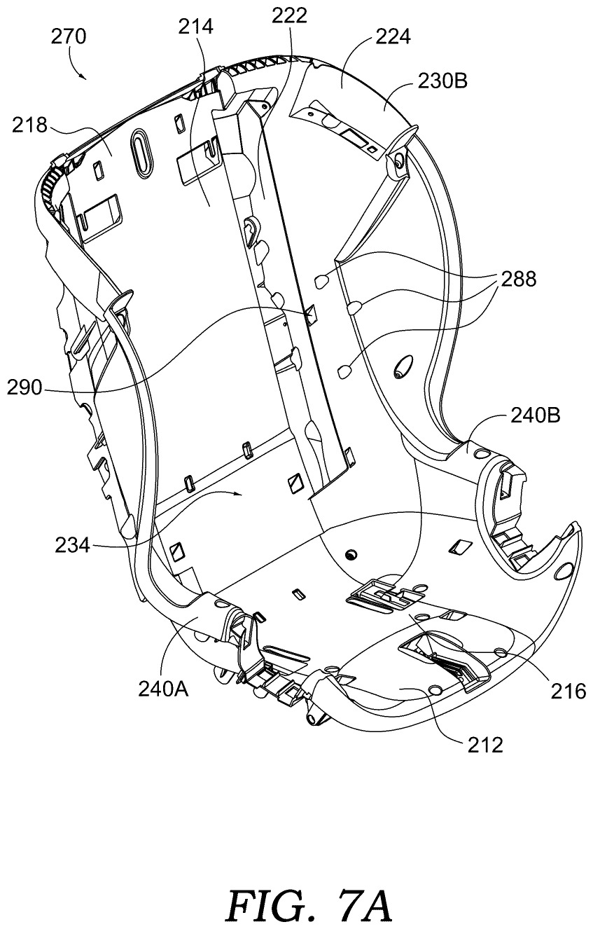

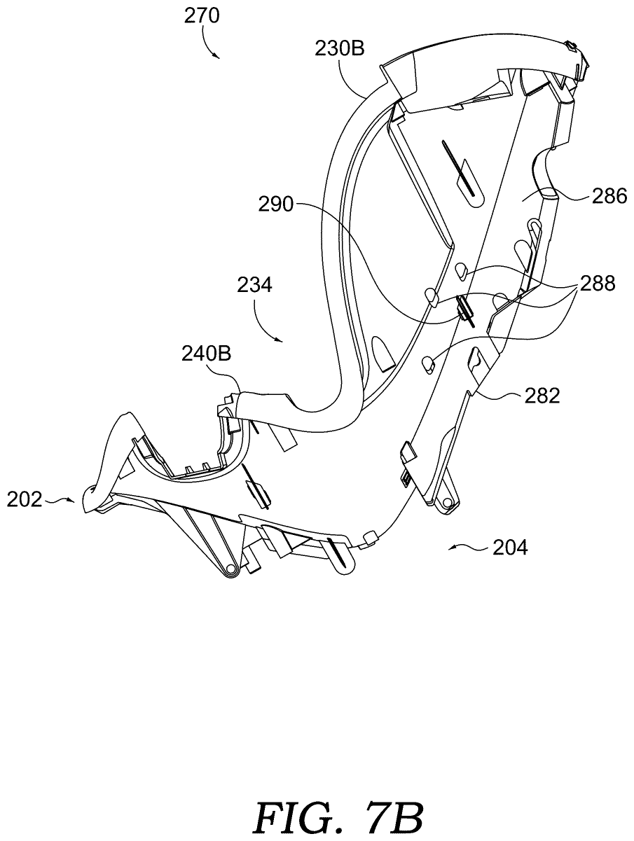

Turning to FIGS. 7A and 7B, inner shell portion 280 generally forms the interior surfaces of the seat shell 200 that define the occupant cavity 234 (e.g., the inner surfaces 232, the seat pan 216 and the seat back 218), and the grooves 222 which may house mechanisms for the securement and adjustment of the headrest 220 within a groove structure 282. In the example child seat 100 of FIG. 1, the attachment structure 470 is secured to the inner shell so that at least a portion of the attachment structure 470 is adjacent a side surface 286 of the groove 222, so that in the event of a side impact event the forces transmitted through the side impact protection structure 400 may be at least partially absorbed and dispersed by the side surface 286 and any rigid structural elements within it. Fastener ports 288 are positioned on the sidewall 230 through which fasteners can engage fastener receivers in the cover, as further described herein. Surface features, such as surface feature 290, may create projections or other regions where the surface of the inner shell portion 280 where the attachment structure 470 is attached to the inner shell portion 280 is not generally smooth (e.g., the inner shell portion 280 may have protrusions, bulges, recesses, or other surface features to make space for other components to be positioned adjacent to or attached to the inner shell portion 280 or other parts of the child seat 100).

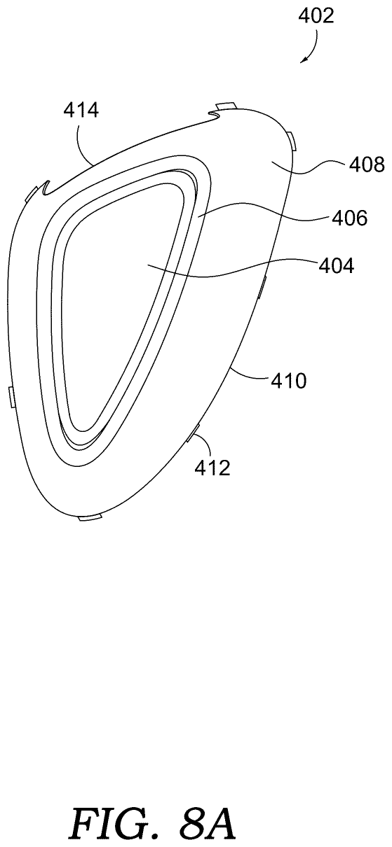

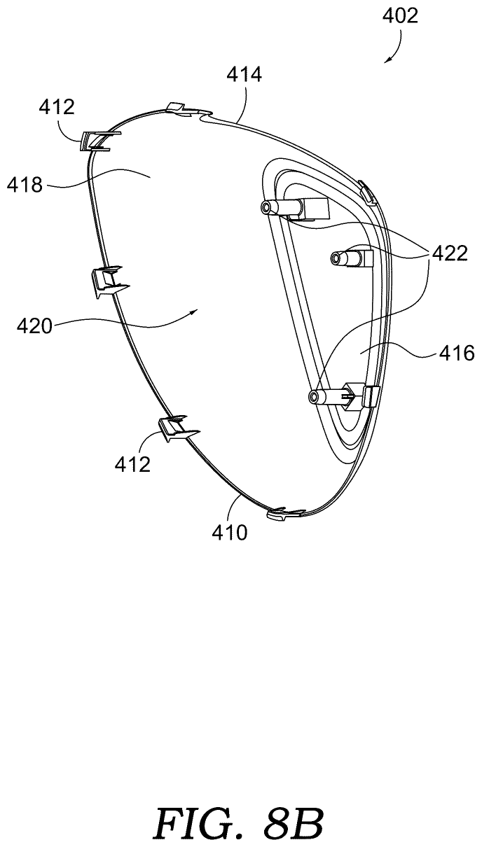

Turning to FIGS. 8A and 8B, several views of the cover 402 are depicted. The cover 402 comprises an impact surface 404 with an impact surface perimeter 406. A collar 408 extends from the impact surface perimeter 406 to a collar edge 410. In the example of FIGS. 8A-B, the collar 408 has a varying width between the impact surface perimeter 406 and the collar edge 410. The contour of the collar edge 410 corresponds to the profile of the outer shell back to which the collar edge touches and is configured so that the impact surface 404 may be generally oriented to be parallel to the longitudinal plane 210. Along the collar edge 410 may be a plurality of tabs 412 that may be used to assist in aligning and attaching the cover 402 to the outer shell aperture 260. The collar edge 410 may also include one or more recesses, such as recess 414, to match the contour of the outer shell portion 250 along the perimeter 261 of the outer shell aperture 260 (e.g., to accommodate the bumper 409 shown in FIG. 1).

As seen in FIG. 8B, an inner face 416 of the impact surface 404 and an inner face 418 of the collar 408 define a cover cavity 420. One or more fastener receivers 422 may extend from the impact surface inner face 416, which may be used to fasten the cover 402 to the attachment structure 470, as further described below.

The cover 402 may be comprised of a rigid material such as polypropylene or other plastics including but not limited to ABS, Nylon and TPE. In other aspects, the cover may comprise a foam material such as expanded polystyrene or expanded polypropylene.

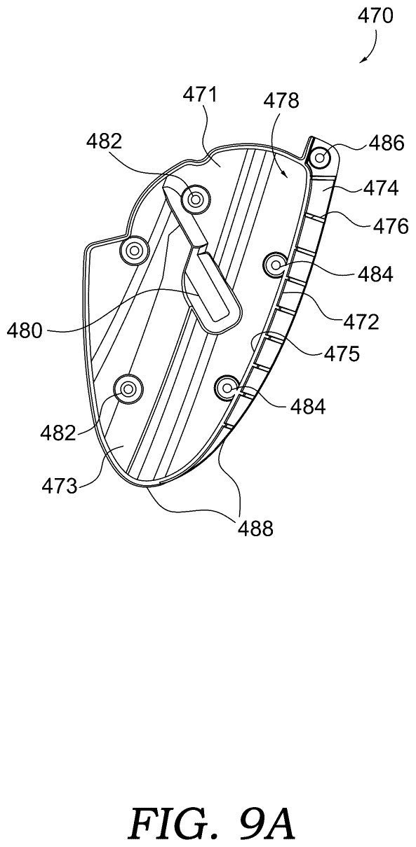

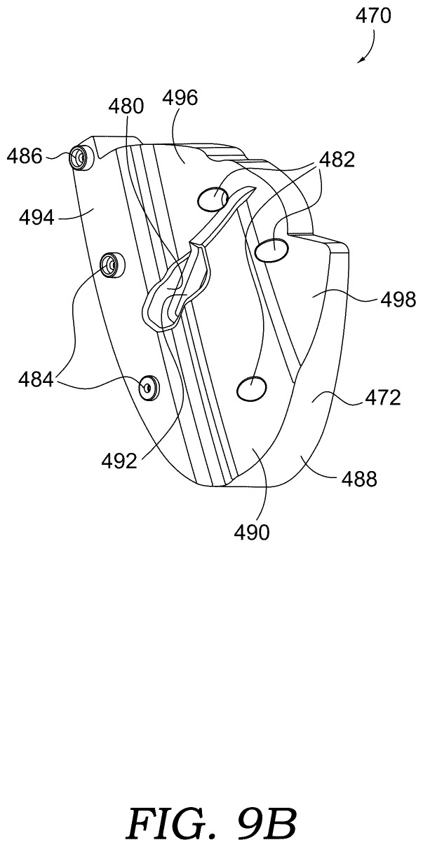

Turning to FIGS. 9A and 9B, several views of the attachment structure 470 are depicted. Attachment structure has a body 471 with a cover-facing side from which a perimeter flange 472 extends outwardly. The inner surface 473 of the body 471 and the inner surface 475 of the perimeter flange 472 define an attachment structure cavity 478 into which a proximal portion of the energy-absorbing element 430 may be inserted. Along a portion of the perimeter flange 472 extends a second flange 474, which may be an extension of the body 471 outside of the perimeter flange 472. A plurality of ribs 476 may extend between the outer side of the perimeter flange and the second flange to provide additional support and rigidity. The attachment structure body 471 includes a plurality of cover fastener ports 482 through which fasteners may extend through to be attached to the one or more fastener receivers 422, and a plurality of fastener receivers 484 into which fasteners may be secured to attach the feature attachment structure 470 to the inner shell portion 280. The overall outer profile 488 is configured to fit within the perimeter 261 of the outer shell portion 250, allowing the attachment structure 470 to be inserted through the outer shell aperture 260 and attached to the inner shell portion 280 once the outer shell portion 250 and inner shell portion 280 are mated together. The second flange 474 may include one or more recesses 486 to make space for components or features on the inner surface of the inner shell portion 270. The attachment side 490 of the body 471 may comprises multiple surfaces 494, 496 and 498, each contoured to correspond with the matching contours of the inner shell portion 280 along the shell back 214 where the attachment structure 470 is attached to the inner shell portion 280.

The attachment structure 470 may comprise a rigid material, such as polypropylene or other plastics including but not limited to ABS, Nylon and TPE.

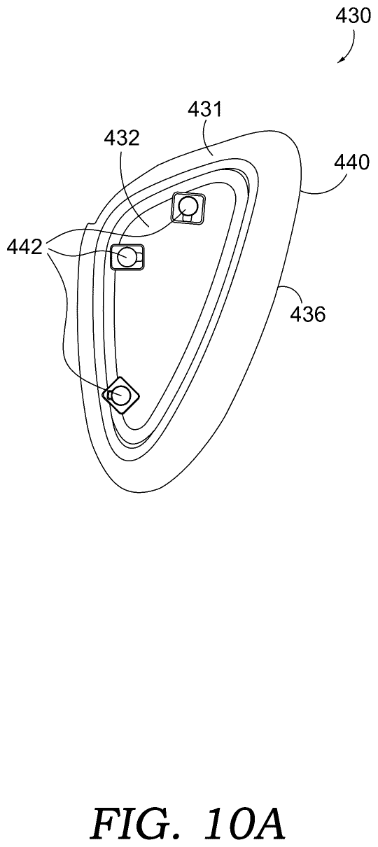

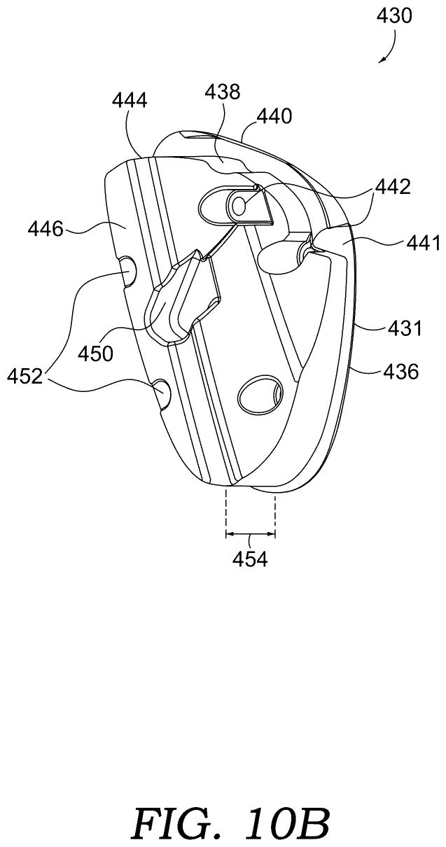

The energy-absorbing element 430 is depicted in FIGS. 10A and 10B. Energy-absorbing element 430 may comprise a first portion 431 having a shape to fit within the cover cavity 420 of the cover 402, and a second portion 444 having a shape to fit within the attachment structure cavity 478. As seen in FIG. 10A first outer surface 432 that generally matches the contour of the inner face 416 of the cover cavity 420, and a second outer surface 436 that generally matches the contour of the inner face 418 of the collar 408. The second outer surface 436 extends to a foam insert first perimeter 440, which is greater than the perimeter of the perimeter flange 472. One or more fastener recesses 442 may extend through the first outer surface 432, with the fastener recesses 442 generally matching the position and shape of the one or more fastener receivers 422 of the cover. As seen in FIG. 10B FIG. 10B, the fastener recesses 442 extend through the entire width of the energy-absorbing element 430 and are also configured on the attachment-structure facing side to match the contours of the cover fastener ports 482 of the attachment structure 470. The second portion 444 of the energy-absorbing element 430 may have a width 454 that varies to correspond to the match the width of the perimeter flange 472 of the attachment structure 470 and one or more recesses, such as recesses 450, to match the features such as feature 480 of the attachment structure 470. In particular, recesses 452 match the contours of the plurality of fastener receivers 484.

Referring back again to FIG. 10B, between the first portion 431 and the second portion 444 is a transition surface 441. In the example of child seat 100, the transition surface 441 is not enclosed by the cover 402 or the attachment structure 470, and thus may directly abut one or more surfaces of the outer shell portion 250. Without being bound to any particular theory, because the energy-absorbing element 430 directly abuts both the outer shell portion 250 and the attachment structure 470, this may further disperse the energy from a side impact event more evenly throughout the child seat 100.

The energy-absorbing element 430 may comprise a foam material such as expanded polystyrene or expanded polypropylene. In other aspects, the energy-absorbing element 430 may be replaced by an insert that comprises an outer shell surrounding an energy-absorbing fill (e.g., a plurality of beads or other granules). In yet other aspects, the energy-absorbing element may comprise a honeycomb or other structure comprised of plastic configured to be crushed upon impact. Other energy-absorbing elements may include a combination of materials, in alloy or composite form.

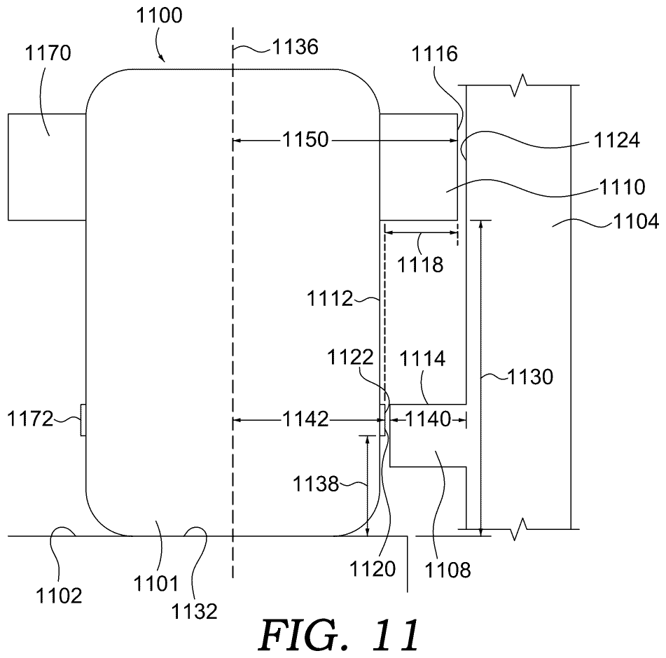

In a second example, and with reference to the schematic illustration of FIGS. 11, which depicts a face-on view of a child seat 1100 with a base 1101 secured to a vehicle seat pan 1102 and adjacent to a vehicle door 1104 with vehicle door armrest 1108, a side impact protection structure 1110 is positioned on a side surface 1112 of the child seat 1100 so that it is above an upper edge 1114 of the vehicle door armrest 1108. A first impact surface 1116 of the side impact protection structure 1110 is a first distance 1118 away from a second impact surface 1120 on the side surface1112 adjacent to the vehicle door armrest 1108. In examples, the second impact surface 1120 may be a surface on second side impact protection structure, or it may be a surface on a shell or base of the child seat 1100 in the proximity of the vehicle door armrest 1108 that is distalmost to a central longitudinal plane 1136 of the child seat 1100, The first distance 1118 is about the same length as a lateral distance 1140 between a side surface 1122 of the vehicle door armrest 1108 and an upper surface 1124 of the vehicle door 1104 that is parallel to the first impact surface 1116. Thus, the first impact surface 1116 is positioned a first length 1130 from a bottom surface 1132 of the base 1101 in the first direction, which may be the vertical direction, and a first lateral length 1134 from the central longitudinal plane 1136; and the second impact surface is positioned a second length 1138 from the bottom surface 1132 in the first direction and a second lateral length 1142 from the central longitudinal plane 1136, the second length 1138 being smaller than the first length 1130, and the second lateral length 1142 being smaller than the first lateral length 1134. In examples, to put the first impact surface 1116 in position to avoid the vehicle door armrest 1108 while putting the second impact surface 1120 in a position adjacent to the vehicle door armrest 1108 in a majority of vehicles, the second length 1138 is less than 20 cm and the second length 1138 is at least 20 cm less than the first length 1130.

In the event of a side impact collision, the first impact surface 1116 thus contacts the vehicle door upper surface 1124 at about the same time as the second impact surface 1120 contacts the side surface 1122 of the vehicle door armrest 1108. These two contacts occurring nearly simultaneously thus minimize the amount of rolling rotation (e.g., around a longitudinal axis proximate to the intersection of the upper surface 1124 and the side surface 1122 of the vehicle door armrest 1108) that the child seat 1100 might otherwise experience due to contact with the vehicle door armrest 1108 during a side impact event.

The child seat 1100 may have a third impact surface 1170 and a fourth impact surface 1172 corresponding with the first impact surface 1116 and the second impact surface 1120 and having generally symmetrical features and positioning mirrored about the central longitudinal plane 1136.

In examples, the side impact protection structure 1110 may have a similar structure to that of the side impact protection structure 400 described herein, and may be attached to a seat shell of the child seat 1100 in a manner similar to the manner described above. Furthermore, in examples where the child seat 1100 comprises a seat shell that can adopt a forward-facing position and a rearward-facing position, the side impact protection structure 1110 may be positioned such that even in a rearward-facing position, the first impact surface 1116 (or third impact surface 1170, depending on which is closed to the vehicle door 1104) will still positioned to avoid impacting the side surface 1122 of the vehicle door armrest 1108. Additionally, it is to be understood that the concepts around the positioning and structure of the one or more side impact protection structures exemplified in FIGS. 1-11 above may be used separately or in combination with each other.

While the side impact protection structures described above generally include a cover, an attachment structure and an energy absorbing element, it is contemplated that aspects of the present disclosure may be practiced with side impact protection structures having different configurations, such as a side impact protection structure without a separate cover, or a side impact protection structure that is attached to the car seat in a different manner than described herein.

“A,” “an,” “the,” “at least one,” and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; or nearly). If the imprecision provided by “about” is not otherwise understood in the art with this ordinary meaning, then “about” as used herein indicates at least variations that may arise from ordinary methods of measuring and using such parameters. As used in the description and the accompanying claims, a value is considered to be “approximately” equal to a stated value if it is neither more than 5 percent greater than nor more than 5 percent less than the stated value. In addition, a disclosure of a range is to be understood as specifically disclosing all values and further divided ranges within the range.

The terms “comprising,” “including,” and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

For consistency and convenience, directional adjectives may be employed throughout this detailed description corresponding to the illustrated aspects and aspects. Those having ordinary skill in the art will recognize that terms such as “above,” “below,” “upward,” “downward,” “top,” “bottom,” etc., may be used descriptively relative to the figures, without representing limitations on the scope of the disclosure, as defined by the claims.

The following clauses represent example aspects of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1. A child seat comprising: a base comprising a receiving portion and a bottom surface, the bottom surface defining a bottom surface plane and having a rear edge; a seat shell comprising a shell bottom having a lower portion configured to interface with the receiving portion of the base, a shell back extending upwards from the shell bottom; a first impact protection structure positioned on a first lateral side of the shell back, the first impact protection structure comprising a first energy-absorbing element formed of an energy-absorbing material and a first cover at least partially covering the first energy-absorbing element and comprising a first impact surface; and a second impact protection structure positioned on a second lateral side of the shell back, the second impact protection structure comprising a second energy-absorbing element formed of the energy-absorbing material and a second cover at least partially covering the second energy-absorbing element and comprising a second impact surface: wherein: the seat shell can be selectively positioned on the base in at least a rearward-facing position and a forward-facing position; and a common transverse plane intersects the first impact surface and the second impact surface in both the forward-facing position and the rearward-facing position.

Clause 2. The child seat of clause 1, wherein the common transverse plane is spaced from the bottom surface plane by a first distance of between 10 cm and 20 cm.

Clause 3. The child seat of clause 2, wherein the common transverse plane is a first common transverse plane, and a second common transverse plane parallel to the first common transverse plane and spaced at least 4 cm from the first common transverse plane also intersects the first impact surface and the second impact surface in both the forward-facing position and the rearward-facing position.

Clause 4. The child seat of any of clauses 1 to 3, further comprising a third impact protection structure positioned on the first lateral side and aligned opposite the second impact protection structure across a midline plane of the child seat, and a fourth impact protection structure positioned on the second lateral side and aligned opposite the first impact protection structure across the midline plane.

Clause 5. The child seat of any of clauses 1 to 4, wherein the first impact protection structure is positioned opposite the second impact protection structure across a longitudinal plane extending between a front end and a rear end of the child seat.

Clause 6. The child seat of any of clauses 1 to 5, wherein a first position of the first impact surface in the forward-facing position and a second position of the second impact surface in the rearward-facing position at least partially overlap.

Clause 7. A child seat comprising: a seat shell comprising: a bottom surface defining a bottom surface plane; a back extending in a first direction from the bottom surface plane; and a first impact protection structure, comprising: an attachment structure having a cover-facing side and an attachment side configured to attach to the back; a cover attached to the cover-facing side, the cover and the attachment structure defining a cavity there between; an energy-absorbing element disposed within the cavity; and a first impact surface on a first side of the cover; wherein the first impact surface is positioned a first length from the bottom surface plane in the first direction and a first lateral length from a central longitudinal plane; and the child seat further comprises a second impact surface that is positioned a second length from the bottom surface plane in the first direction and a second lateral length from the central longitudinal plane, the second length being smaller than the first length, and the second lateral length being smaller than the first lateral length.

Clause 8. The child seat of clause 7, wherein the second length is at least 20 cm less than the first length.

Clause 9. The child seat of clause 8, wherein the second length is less than 20 cm.

Clause 10. The child seat of any of clauses 7 to 9, wherein the child seat comprises a seat shell and a base configured to receive the seat shell, the base comprising the bottom surface and the seat shell comprising the back.

Clause 11. The child seat of clause 10, wherein the second impact surface is located on the base.

Clause 12. The child seat of clause 11, wherein the second impact surface is located on the seat shell.

Clause 13. The child seat of clause 12, wherein the second impact surface comprises a second impact protection structure comprising a second energy-absorbing element attached to the seat shell.

Clause 14. The child seat of clause 13, wherein the second length is at least 20 cm less than the first length.

Clause 15. The child seat of clause 14, wherein the second length is less than 20 cm.

Clause 16. A child seat comprising: a base comprising a receiving portion; and a seat shell comprising: a shell bottom having a lower portion configured to interface with the receiving portion of the base; a shell back extending in a first direction from the shell bottom; and an impact protection structure, comprising: an attachment structure having a cover-facing side and an attachment side configured to attach to the shell back; a cover attached to the cover-facing side, the cover and the attachment structure defining a cavity there between; an energy-absorbing element disposed within the cavity; and a first impact surface on a first side of the cover; wherein the seat shell comprises an inner shell portion and an outer shell portion, and the attachment structure is attached to the inner shell portion and at least partially extends through an aperture in the outer shell portion.

Clause 17. The child seat of clause 16, wherein the cover directly abuts the outer shell portion.

Clause 18. The child seat of clause 17, wherein at least a first portion of the energy-absorbing element is inserted within a cavity defined by an attachment structure perimeter flange having a first perimeter, and a second portion of the energy-absorbing element has a second perimeter that is greater than the first perimeter.

Clause 19. The child seat of clause 18, wherein the energy-absorbing element directly abuts both the attachment structure and the outer shell portion.

Clause 20. The child seat of any of clauses 1 to 16, wherein the energy-absorbing element comprises a foam material.

Many different arrangements of the various components depicted, as well as components not shown, are possible without departing from the scope of the claims below. Aspects in this disclosure are described with the intent to be illustrative rather than restrictive. Alternative aspects will become apparent to readers of this disclosure after and because of reading it. Alternative means of implementing the aforementioned can be completed without departing from the scope of the claims below. Some features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, aspects that may be practiced. It is to be understood that other aspects may be utilized and structural or logical changes may be made without departing from the scope of the present disclosure. Therefore, the preceding detailed description is not to be taken in the limiting sense, and the scope of aspects is defined by the appended claims and their equivalents.

What is claimed is:

1. A child seat comprising:
a base comprising a receiving portion and a bottom surface, the bottom surface defining a bottom surface plane and having a rear edge;
a seat shell comprising
a shell bottom having a lower portion configured to interface with the receiving portion of the base,
a shell back extending upwards from the shell bottom;
a first impact protection structure positioned on a first lateral side of the shell back, the first impact protection structure comprising a first energy-absorbing element formed of an energy-absorbing material and a first cover at least partially covering the first energy-absorbing element and comprising a first impact surface; and
a second impact protection structure positioned on a second lateral side of the shell back, the second impact protection structure comprising a second energy-absorbing element formed of the energy-absorbing material and a second cover at least partially covering the second energy-absorbing element and comprising a second impact surface:
wherein:
the seat shell can be selectively positioned on the base in at least a rearward-facing position and a forward-facing position; and
a common transverse plane intersects the first impact surface and the second impact surface in both the forward-facing position and the rearward-facing position.

2. The child seat of claim 1, wherein the common transverse plane is spaced from the bottom surface plane by a first distance of between 10 cm and 20 cm.

3. The child seat of claim 2, wherein the common transverse plane is a first common transverse plane, and a second common transverse plane parallel to the first common transverse plane and spaced at least 4 cm from the first common transverse plane also intersects the first impact surface and the second impact surface in both the forward-facing position and the rearward-facing position.

4. The child seat of claim 1, further comprising a third impact protection structure positioned on the first lateral side and aligned opposite the second impact protection structure across a midline plane of the child seat, and a fourth impact protection structure positioned on the second lateral side and aligned opposite the first impact protection structure across the midline plane.

5. The child seat of claim 1, wherein the first impact protection structure is positioned opposite the second impact protection structure across a longitudinal plane extending between a front end and a rear end of the child seat.

6. The child seat of claim 1, wherein a first position of the first impact surface in the forward-facing position and a second position of the second impact surface in the rearward-facing position at least partially overlap.

7. A child seat comprising:
a seat shell comprising:
a bottom surface defining a bottom surface plane;
a back extending in a first direction from the bottom surface plane; and
a first impact protection structure, comprising:
an attachment structure having a cover-facing side and an attachment side configured to attach to the back;
a cover attached to the cover-facing side, the cover and the attachment structure defining a cavity there between;
an energy-absorbing element disposed within the cavity; and
a first impact surface on a first side of the cover;
wherein the first impact surface is positioned a first length from the bottom surface plane in the first direction and a first lateral length from a central longitudinal plane; and
the child seat further comprises a second impact surface that is positioned a second length from the bottom surface plane in the first direction and a second lateral length from the central longitudinal plane, the second length being smaller than the first length, and the second lateral length being smaller than the first lateral length.

8. The child seat of claim 7, wherein the second length is at least 20 cm less than the first length.

9. The child seat of claim 8, wherein the second length is less than 20 cm.

10. The child seat of claim 7, wherein the child seat comprises a seat shell and a base configured to receive the seat shell, the base comprising the bottom surface and the seat shell comprising the back.

11. The child seat of claim 10, wherein the second impact surface is located on the base.

12. The child seat of claim 11, wherein the second impact surface is located on the seat shell.

13. The child seat of claim 12, wherein the second impact surface comprises a second impact protection structure comprising a second energy-absorbing element attached to the seat shell.

14. The child seat of claim 13, wherein the second length is at least 20 cm less than the first length.

15. The child seat of claim 14, wherein the second length is less than 20 cm.

16. A child seat comprising:
a base comprising a receiving portion; and
a seat shell comprising:
a shell bottom having a lower portion configured to interface with the receiving portion of the base;
a shell back extending in a first direction from the shell bottom; and
an impact protection structure, comprising:
an attachment structure having a cover-facing side and an attachment side configured to attach to the shell back;
a cover attached to the cover-facing side, the cover and the attachment structure defining a cavity there between;
an energy-absorbing element disposed within the cavity; and
a first impact surface on a first side of the cover;
wherein the seat shell comprises an inner shell portion and an outer shell portion, and the attachment structure is attached to the inner shell portion and at least partially extends through an aperture in the outer shell portion.

17. The child seat of claim 16, wherein the cover directly abuts the outer shell portion.

18. The child seat of claim 17, wherein at least a first portion of the energy-absorbing element is inserted within a cavity defined by an attachment structure perimeter flange having a first perimeter, and a second portion of the energy-absorbing element has a second perimeter that is greater than the first perimeter.

19. The child seat of claim 18, wherein the energy-absorbing element directly abuts both the attachment structure and the outer shell portion.

20. The child seat of claim 16, wherein the energy-absorbing element comprises a foam material.
